(19) United States
(12) Patent Application Publication
(10) Pub. No.: US 2008/0085122 A1
(43) Pub. Date: Apr. 10, 2008

(54) Optical Data Transmission, Optical Data Transceivers And Method Of Manufacturing And Packaging Thereof

(75) Inventor: Piet De Pauw, Oudenaarde (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Melexis NV, Leper (BE)

(21) Appl. No.: 10/579,027

(22) PCT Filed: Nov. 10, 2004
(86) PCT No.: PCT/IB04/03674

§ 371 Date: Jul. 17, 2007

(30) Foreign Application Priority Data
Nov. 10, 2003 (GB) 0326106.2
Apr. 19, 2004 (GB) 0408653.4
Apr. 19, 2004 (GB) 0408660.9

(51) Int. Cl. G02B 6/42; H04B 10/00

(52) U.S. Cl. 398/139; 264/1.25; 385/31

(57) ABSTRACT

An optical data transceiver (100) comprises an integrated circuit (101), having provided on one side thereof a light sensing emitting means (104). A reflecting and receiving means (102), is mounted on the same surface of integrated circuit (101) as the light sensing or emitting means (104). The reflector means is open at both ends and has shaped and reflective internal surfaces (103). The reflecting and receiving means (102) is adapted at one end to receive a Plastic Optical Fibre (POF) (150) into connection therewith and at the other end is aligned with the light sensing or emitting means (104). In this way, the reflecting and receiving means is operable to direct light proceeding from the end of the fibre (150) to the light sensing means (104),or direct light from the light emitting means (104) to the end of the fibre (150), and is further operable to retain the POF (150) in position relative to the light sensing or emitting means (104).

The present invention relates to optical data transmission systems and in particular to optical data transceivers, means for optically coupling optical data transceivers with optical fibres and methods of manufacture and packaging of optical data transceivers.

Optical data transmission systems use light to carry digital data along fibre optic cables. There is a growing move to use optical data transmission systems for reasons of speed, bandwidth and immunity to interference along the transmission fibre. In such optical data transmission systems light is generated by a first transceiver, coupled to the fibre, and travels along the fibre to its far end whereupon it is incident upon a second transceiver. The first transceiver acts to convert electrical signals into optical signals and the second transceiver acts to convert the optical signals back into electrical signals. This process may of course be reversed, with signals being sent from the second transceiver to the first transceiver, if desired.

Each transceiver has an optically active element or elements. Typically the optically active elements are a light emitting means and a light sensing means. It is however possible, if data transmission is required in a single direction only, that transceivers may be adapted only to emit light or to sense light i.e. to have a single optically active element being either a light emitting means or a light sensing means as appropriate. In this application, the term transceiver is used to encompass all three possibilities.

Traditionally optical transmissions systems have used Glass Optical Fibres (GOF) as a transmission medium. GOF have low transmission losses and are essential in long distance telecommunications. For shorter range transmissions, for example around a home or a vehicle, much higher transmission losses can be accepted whilst still achieving a desired data rate and/or error rate. Over such shorter distances, the transmitted power can also be reduced whilst maintaining adequate received signal. This being the case, Plastic Optical Fibre (POF) can be used in place of GOF in such systems.

POF has a greater diameter than GOF, typically around 1000 micron compared with around 100 micron for a typical GOP. To extract the maximum optical energy from the fibre in any application requires good optical coupling between the fibre and the particular light sensitive element. For high speed data transmission the switching speed of the light sensitive element must be high. To achieve high speeds the size of the light sensitive element must be kept as small as possible as a larger light sensitive element will generally have a larger inherent capacitance than a smaller light sensitive element and will hence have a slower switching speed.

Conventionally, optical transceivers are packaged in a protective housing into which an optical fibre may be inserted and releaseably retained. To allow the fibre to be inserted and retained, an opening is provided in the housing, said opening being of a cross-section corresponding to the cross-section of the optical fibre and extending from the surface of the housing to the light emitting and or light sensing means of the transceiver. Such package designs as are known are specially adapted for use with GOF and as a result are not particularly suited for use with larger diameter POF. In particular, as the cross-section of even a GOF is typically greater than that of the light sensing or emitting means, a proportion of the light that travels along the optical fibre is not incident upon the light sensing means. These losses reduce the effective intensity of the transmitted data signals and hence increase the Bit Error Rate, and reduce the efficiency, the sensitivity, data rate, and maximum communication range of the signal from their optimum values and are exacerbated if POF is used rather than GOF due to the larger diameter of POF.

One way to combat these losses is to increase the intensity of the emitted signal. There are however legal limits for the maximum output signal intensity in optical data transmission systems. These limits are imposed to protect the vision of any person working with or using such devices. As a result, the losses cannot be fully compensated by increasing signal strength.

It is therefore an object of the present invention to provide means for coupling an optical data transceiver to a POF and to provide an optical data transceiver adapted to be coupled to a POF which overcomes or alleviates some or all of the above problems. It is also an object of the present invention to provide a method or methods of manufacturing and packaging an optical data transceiver that overcomes or alleviates some or all of the above problems.

According to a first aspect c f the present invention there is provided a means for optically coupling an optical fibre to an integrated circuit: the circuit including at least one optically active element; and the means for coupling comprising reflecting and receiving means for mounting on a surface of said integrated circuit, said reflecting and receiving means being adapted to receive the optical fibre into optically coupled connection therewith.

According to a second aspect of the invention there is provided a method of for optically coupling an optical fibre to an integrated circuit, the integrated circuit including at least one optically active element, said coupling being achieved by the steps of: mounting on a surface of said integrated circuit reflecting and receiving means; and optically coupling said optical fibre to said reflecting and receiving means.

In this manner, optical coupling may be provided between an optical fibre and an optically active element or elements wherein the losses of transmitted optical signals are reduced and hence the efficiency, the sensitivity, data rate, Bit Error Rate, and maximum communication range of the data signals are improved.

The reflecting and receiving means preferably has two open ends. One end is preferably adapted to receive and retain an optical fibre and the second end is preferably adapted to fit around an optically active element or elements. The reflecting and receiving means may have shaped and reflective inner surfaces operable to direct light from the optical fibre onto said optically active element or elements and to direct light from said optically active elements into said optical fibre. The inner surfaces are preferably curved.

Preferably a gel blob is applied to said optically active element or elements. Most preferably, said gel blob is applied so as to form a lens to assist said reflecting and receiving means in directing light from said optical fibre to said optically active element or elements and in directing light from said optically active elements to said optical fibre.

Preferably, the reflecting and receiving means is mounted on the integrated circuit by means of adhesive. Preferably, the integrated circuit is additionally provided with bond pads, which allow electrical connections to be made between the optically active element or elements and external circuitry.

According to a third aspect of the present invention there is provided an optical data transceiver comprising: an integrated circuit comprising at least one optically active element; and a reflecting and receiving means mounted on said integrated circuit, said reflecting and receiving means for receiving and retaining the end of an optical fibre and for directing light from said optical fibre to said optically active element or elements and for directing light from said optically active element or elements to said optical fibre.

In this manner, an optical data transceiver may be provided wherein the losses of transmitted optical signals are reduced and hence the efficiency, the sensitivity, data rate, Bit Error Rate, and maximum communication range of the data signals are improved.

In one preferred embodiment, the optical transceiver is an optical transceiver of the type comprising two optically active elements, a light emitting means and a light sensing means. In an alternative preferred embodiment, the optical transceiver is an optical transceiver of the type comprising a single optically active element being a light emitting means. In a further alternative preferred embodiment, the optical transceiver is an optical transceiver of the type comprising a single optically active element being a light sensing means.

In a particularly preferred embodiment, the optical transceiver is an optical transceiver of the type comprising three optically active elements: a light emitting means operable to emit light in response to received electrical signals; a mounting means suitable for retaining an end of an optical fibre in position adjacent to said light emitting means; a first light sensing means operable to detect light emitted by the light emitting means and reflected from the end of said optical fibre, said first light sensing means being operable to output a signal indicative of the intensity of the reflected light; a second light sensing means operable to detect light incident upon said transceiver unit from an external source via said optical fibre and output electrical signals in response thereto; and control means operable to vary the intensity of the light emitted by the light emitting means in response to the output of the first light sensing means. In such embodiments said optical transceiver unit is adapted to transmit light of a first wavelength and to receive light of a second wavelength. Furthermore said light emitting means is adapted to emit light of a first wavelength and said first light sensing means is adapted such that it detects substantially only light of said first wavelength by means of a filter, an interference coating or otherwise. Said second light sensing device may be an independent light sensing device or may be a portion of the first light sensing means operable to provide a distinguishable signal and which is adapted such that it detects substantially only light of said second wavelength by means of a filter, an interference coating or otherwise.

Preferably, the optical fibre is a plastic optical fibre (POF) or a polymer cladded silica fibre (PCS).

Preferably a gel blob is applied to said optically active elements. Most preferably, said gel blob is applied so as to form a lens to assist said reflector means in directing light from said optical fibre to said optically active element or elements and to direct light from said optically active element or elements to said optical fibre.

The optically active elements may be implemented on a single integrated circuit or may each be implemented on independent integrated circuits, said independent integrated circuits being electrically connected and physically fixed in a desired relative position. Alternatively any combination of the optically active elements may be implemented on a single integrated circuit as is convenient, required or desired.

Preferably, the integrated circuit is additionally provided with bond pads, which allow electrical connections to be made between the optically active element or elements and external circuitry. Preferably, the integrated circuit may be mounted on a substrate or a lead frame and electrical connections between said bond pads provided on said integrated circuit and external circuitry are made via said substrate or lead frame. In some embodiments wherein the integrated circuit is mounted on a substrate, said substrate may be mounted on a second substrate and electrical connections between the first and second substrate may be provided by vias in said first substrate.

Preferably, in embodiments wherein the integrated circuit is mounted on a lead frame or substrate, the optical data transceiver is encapsulated in a protective package.

The present invention may be adapted for use in any optical data transmission system or any optical data link. By use of appropriate combinations of transceiver units duplex, half duplex and simplex links may be provided as appropriate or as desired.

One particular use of optical data transmission systems is in vehicular or automotive control or entertainment systems such as those operating to the MOST standard. Another application for such data transmission systems is for use in transmitting data between a digital imaging device and an image processing means such as those used in various automotive applications including lane following and parking assist.

According to a fourth aspect of the present invention there is provided a method of manufacturing optical data transceivers comprising the steps of: providing an array of integrated circuits on a wafer, each integrated circuit incorporating at least one optically active element; providing a corresponding array of reflecting and receiving means, each reflecting and receiving means within the array operable to retain the end of an optical fibre and to direct light from said optical fibre to said optically active element or elements of one of the integrated circuits and also operable to direct light from said optically active element or elements of one of the integrated circuits to said optical fibre; aligning said array of reflecting and receiving means with said array of integrated circuits and thereby mounting said array of reflecting and receiving means in alignment with said array of integrated circuits; and separating individual optical data transceivers from the array.

In this manner, an optical data transceiver may be provided wherein the losses of transmitted optical signals are reduced and hence the efficiency, the sensitivity, data rate, Bit Error Rate, and maximum communication range of the data signals are improved.

The wafer and the array of reflecting and receiving means are separated into individual optical data transceivers by sawing, laser scribing or any other known semiconductor separation techniques or a combination of two or more such techniques. The individual optical data transceivers can then be mounted onto suitable substrates or packaged, as desired or as appropriate.

In alternative embodiments, the wafer and array of reflecting and receiving means can be separated into optical data transceivers incorporating two or more reflecting and receiving means and two or more integrated circuits to form multiple POF interfaces. In a still further embodiment the array of reflecting and receiving means can provide a plurality of reflecting and receiving means for a corresponding plurality of optically active elements provided on each integrated circuit to provide a multiple POF interface.

Preferably, the method of the fourth aspect of the present invention is adapted to be used to manufacture optical data transceivers according to the third aspect of the present invention. As such, the fourth aspect of the present invention may incorporate any features of the third aspect of the present invention as desired or appropriate.

Preferably, the method further includes the step of packaging the optical data transceiver.

According to a fifth aspect of the present invention there is provided a method of manufacturing a packaged optical data transceiver comprising the following steps: providing an integrated circuit, the integrated circuit incorporating at least one optically active element; mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre; and dispensing a quantity of potting compound on to the surface of said integrated circuit such that only the reflector means and said optically active elements are left uncovered.

In this manner, a packaged optical transceiver may be provided wherein the losses of transmitted optical signals are reduced and hence the efficiency, the sensitivity, data rate, Bit Error Rate, and maximum communication range of the data signals are improved.

The method may preferably further comprise the steps of: providing bond pads on said integrated circuit; mounting said integrated circuit on a suitable substrate; and forming electrical connections between said bond pads and said substrate before dispensing said potting compound.

Preferably said potting compound is dispensed so as to cover substantially the whole of the substrate in addition to the integrated circuit. Preferably, the potting compound is applied in such a manner as to leave exposed bond pads or other means for electrically connecting the substrate to external circuitry. In one particular preferred embodiment, contacts for external electrical connections are provided on the opposite side of the substrate to that the integrated circuit is mounted on and vias are provided in the substrate allowing electrical connection to be made between the contacts and the integrated circuit.

The method according to the fifth aspect of the present invention may incorporate any or all features of the third or fourth aspects of the present invention as desired or as appropriate.

According to a sixth aspect of the present invention there is provided a packaged optical data transceiver manufactured in accordance with the fifth aspect of the present invention.

The optical transceiver unit according to the sixth aspect of the present invention may incorporate any or all of the features described in relation to the third fourth or fifth aspects of the invention as desired or appropriate.

According to a seventh aspect of the present invention there is provided a method of manufacturing a packaged optical data transceiver comprising the following steps: providing an integrated circuit, the integrated circuit incorporating at least one optically active element; mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre, thereby forming an assembly; inserting the assembly into a cavity of a moulding tool ensuring that at least a projection of the moulding tool is in contact with and seals with the reflecting and receiving means; introducing a plastic mould compound into the cavity so as to encapsulate the assembly except for the portion in contact with the projection; and removing the assembly from the cavity, whereby there is an opening defined in the plastic mould encapsulating the assembly through which light may pass to the optically active element or elements.

According to an eighth aspect of the present invention there is provided a method of manufacturing a packaged optical data transceiver comprising the following steps: providing an integrated circuit, the integrated circuit incorporating at least one optically active element; applying a quantity of gel to the integrated circuit to cover at least the optically active elements, thereby forming a gel-coated assembly; inserting the gel-coated assembly into a cavity of a moulding tool ensuring that at least a projection of the moulding tool is in contact with the gel-coated assembly; introducing a plastic mould compound into the cavity so as to encapsulate the gel-coated assembly except for the portion. in contact with the projection; removing the assembly from the cavity, whereby there is an opening defined in the plastic mould encapsulating the assembly through which the assembly can be accessed; and mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre.

The method may preferably further comprise the steps of: providing bond pads on said integrated circuit; mounting said integrated circuit on a suitable lead frame; and forming electrical connections between said bond pads and said lead frame before inserting the assembly into the moulding tool.

Preferably, the peripheral portions of the lead frame are not encapsulated thereby providing means for electrically connecting the substrate to external circuitry.

The methods according to the seventh and eighth aspects of the present invention may incorporate any or all features of the third or fourth aspects of the present invention as desired or as appropriate.

According to a ninth aspect of the present invention there is provided a packaged optical data transceiver manufactured in accordance with the seventh aspect or eighth aspect of the present invention.

The optical transceiver unit according to the ninth aspect of the present invention may incorporate any or all of the features described in relation to the third, fourth, seventh or eighth aspects of the invention as desired or appropriate.

The invention will now be described further herein, with reference to the accompanying drawings, in which:

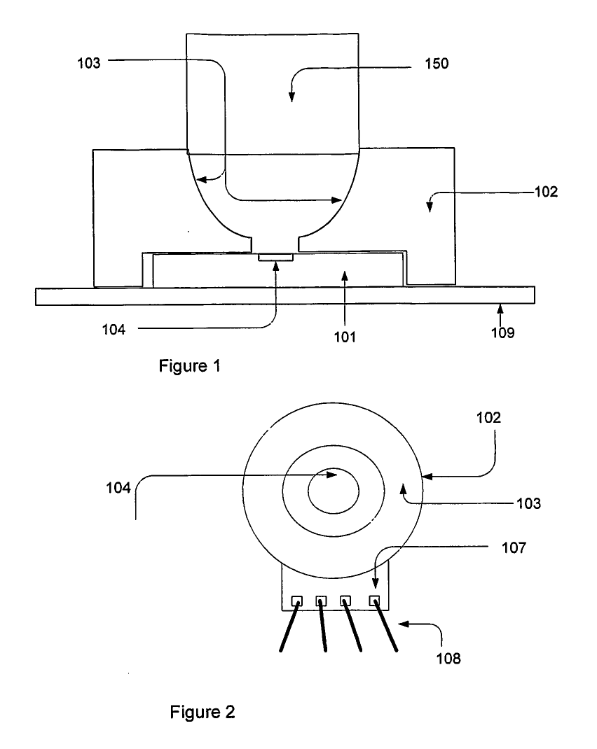

FIG. 1 shows a cross section of a first embodiment of an optical data transceiver according to the invention;

FIG. 2 shows a plan view of the optical data transceiver of FIG. 1;

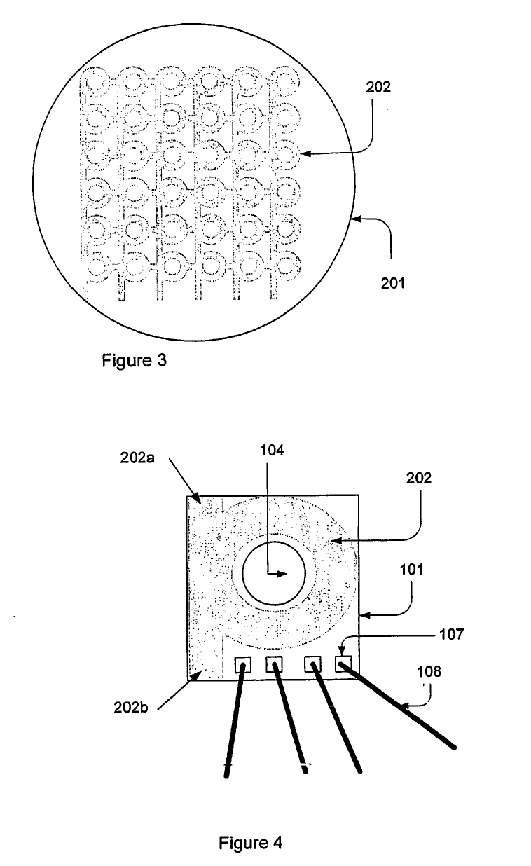

FIG. 3 shows an intermediate stage in the manufacture of an alternative embodiment of optical data transceiver;

FIG. 4 shows a plan view of the completed optical data transceiver of FIG. 3;

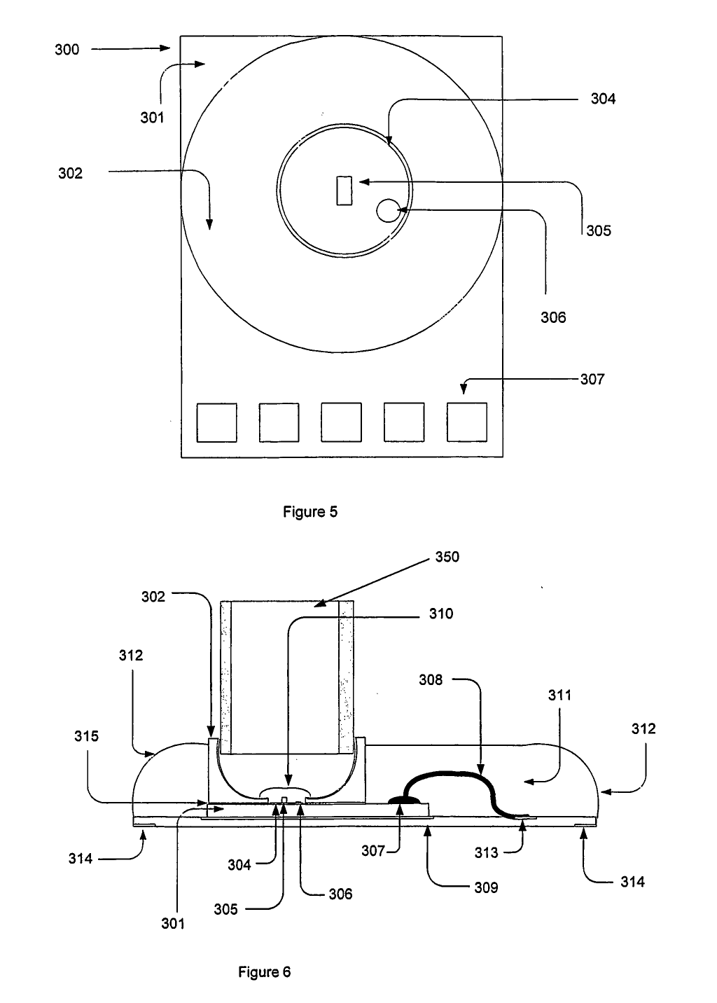

FIG. 5 shows a plan view of an unpackaged optical data transceiver according to the present invention;

FIG. 6 shows a cross-sectional view of the optical data transceiver of FIG. 5, packaged according to a packaging method according to the present invention;

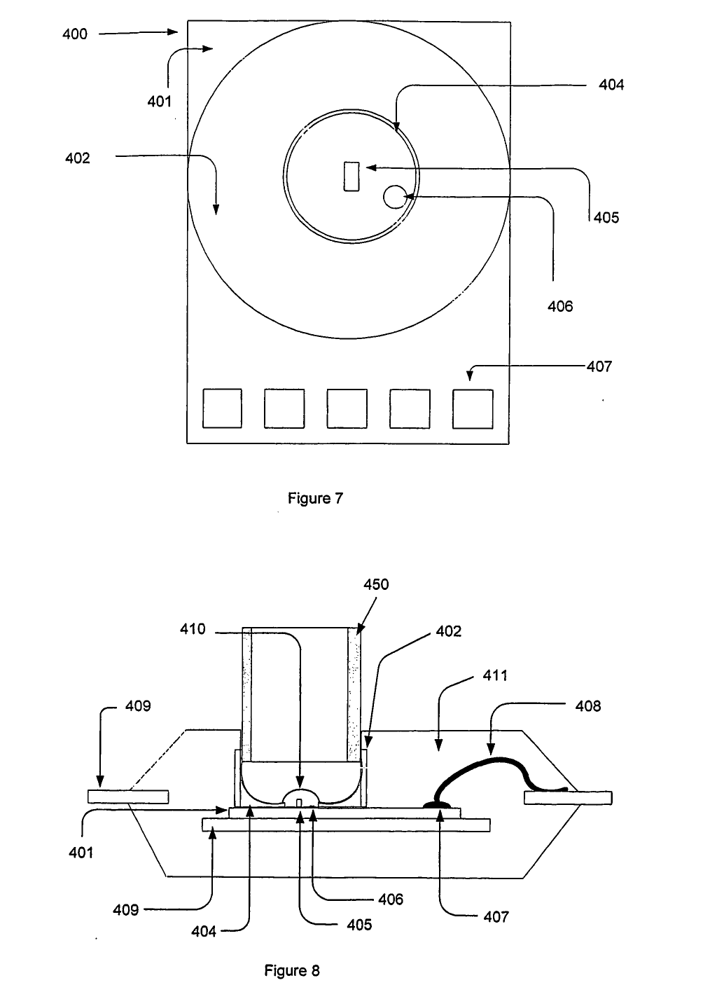

FIG. 7 shows a plan view of an unpackaged optical data transceiver according to the present invention; and

FIG. 8 shows a cross-sectional view of the optical data transceiver of FIG. 7, packaged according to an alternative packaging method, according to the present invention.

Referring now to the figures, FIG. 1 shows a cross-section of an optical data transceiver 100, which comprises an integrated circuit 101, having provided on one side thereof a light sensing means 104. The integrated circuit 101 is mounted on a substrate 109, but may in alternative embodiments not be mounted on a substrate, if desired. A reflecting and receiving means 102, is mounted on the same surface of integrated circuit 101 as the light sensing means 104. The reflector means is open at both ends and has shaped and reflective internal surfaces 103. The reflecting and receiving means 102 is adapted at one end to receive a Plastic Optical Fibre (POF) 150 into connection therewith and at the other end is aligned with the light sensing means 104. In this way, the reflecting and receiving means is operable to direct light proceeding from the end of the 150 to the light sensing means 104, and is further operable to retain the POF 150 in position relative to the light sensing means 104.

In order to direct light from the POF 150 the reflecting and receiving means 102 has a curved inner surface which is adapted to reflect a large proportion of incident light. The surface may be adapted to reflect light by being polished, metallised or covered with a reflective coating. To improve reflective performance if the surface is polished, the whole reflecting and receiving means 102 may be formed from white material.

The reflecting and receiving means 102 can be mounted on the integrated circuit 101 in any suitable manner. For example, a suitable adhesive material can be used. For additional stability, the reflecting and receiving means 102 may be further shaped so as to make contact with the substrate 109 on one or more sides of the integrated circuit 101. The POF 150, is retained in the open end of the reflecting and receiving means 102 by any suitable means which allows optical coupling of the POF to the moulding 102.

Referring now to FIG. 2, which shows a plan view of the embodiment of FIG. 1, it can be seen that the integrated circuit extends away from the reflecting and receiving means 102 on at least one side. On this extended portion of the integrated circuit, bond pads 107 are provided to enable electrical connections 108 to be made between the integrated circuit 101 and the substrate 109 or any other external circuitry.

The integrated circuit 101 may also comprise suitable control and or processing circuitry to process signals generated by the light sensing means 104 and to generate signals for output to other devices connected to the integrated circuit 101 via bond pads 107.

In alternative embodiments, the integrated circuit 101 may comprise light emitting means and additional light sensing means, operable to monitor the performance of the light emitting means. Integrated circuits 101 incorporating such additional elements are discussed in more detail later in the specification.

Referring now to FIGS. 3 and 4, an intermediate stage in manufacture of such optical data transceivers 100 is shown. Firstly, an array of interconnected reflecting and receiving means 202 is formed. This reflecting and receiving means array 202 is then mounted on a silicon wafer 201 upon which is provided a matching array of integrated circuits 101. Care is taken to ensure the reflecting and receiving means array 202 is aligned with the integrated circuit 101 array so that each reflecting and receiving means 102 is aligned with the light sensing means 104 of each integrated circuit 101. The reflecting and receiving means array 202 is mounted to the wafer 201 by means of adhesive or any other suitable manner, as desired or as appropriate.

The wafer 201 and the reflecting and receiving means array 202 are separated into individual optical data transceivers by sawing, laser scribing or any other known semiconductor separation techniques or a combination of two or more such techniques. The individual optical data transceivers can then be mounted onto suitable substrates or packaged, as desired or as appropriate. As a result of the separation from the array, the reflecting and receiving means may have side portions 202a, 202b.

In alternative embodiments, the wafer 201 and reflecting and receiving means array 202 can be separated into optical data transceivers incorporating two or more reflecting and receiving means 102 and two or more integrated circuits to form multiple POF interfaces. In a still further embodiment the reflecting and receiving means array 202 can provide a plurality of reflecting and receiving means 102 for a corresponding plurality of light sensing means provided on each integrated circuit 101 to provide a multiple POF interface.

Referring now to FIGS. 5 and 6, one embodiment of an optical data transceiver 300 according to the present invention comprises an integrated circuit 301 upon which is implemented second light sensing means 304, light emitting means 305 and first light sensing means 306, a reflecting and receiving means 302 and bond pads 307, said bond pads being electrically connected to said integrated circuit 301.

The reflecting and receiving means 302 is operable to direct light emitted by the light emitting means 305 at wide angles into an optical fibre 350 and to direct light proceeding from the end of optical fibre 350 to the first and second light sensing means 306, 304. It is also operable to retain the optical fibre 350 in position relative to the light emitting means 305 and the first and second light sensing means 306, 304. The reflecting and receiving means 302 is mounted on to the integrated circuit 301 by adhesive 315. In order to direct light from the light emitting means 305 into the optical fibre 350, the reflecting and receiving means 302 has a curved inner surface 303 which is adapted to reflect a large proportion of incident light. The surface 303 may be adapted to reflect light by being polished, metallised or covered with a reflective coating. To improve reflective performance if the surface is polished, the whole reflecting and receiving means 302 may be formed from white material.

Referring now to FIG. 6, the integrated circuit 301 is mounted on a substrate 309. The substrate 309 is provided with bond pads 313 and connection pads 314. Connections are made by way of wires (or any other suitable means) between the bond pads 307 on the integrated circuit 301 and the bond pads 313 on the substrate. The bond pads on the substrate 309 are connected to further connection pads 314 by vias through said substrate 309 by means of which the optical transceiver 300 may be connected to external circuitry.

The optical transceiver is packaged by taking the integrated circuit 301 and attached light emitting means 305, and mounting them on said substrate 309. Before packaging, said reflecting and receiving means 302 is mounted on said integrated circuit 301, said reflecting and receiving means 302 being aligned so as to reflect light from said light emitting means into said optical fibre 350 and to reflect light from said optical fibre onto said light sensing means 306, 304.

Once the reflecting and receiving means 302 is in position, a blob of gel 310 is applied to the optically active elements. The blob of gel 310 may be amorphous or may be shaped so as to form a lens and accentuate the effect of the reflecting and receiving means 302. A potting compound 311 is then dispensed onto the surface of the integrated circuit 301, and substrate 309 so as to cover their upper surfaces except that portion upon which the reflecting and receiving means 302 sits. The potting compound 311 provides protection for all the components of the optical transceiver whilst leaving an opening through which an optical fibre 350 may be inserted to allow light to be directed to said light sensing means 304 and directed away from said light emitting means 305. The potting compound is in a fluid state when applied to the substrates 301, 309 and as such the surface tension of the potting compound before it sets results in the curved ends 312 of the package.

The gel blob provides protection for the optically active elements during and after potting. It is also possible that, the gel blob 310 may be added after potting or may be omitted altogether, if desired. The gel may be any suitable transparent compound such as a transparent epoxy or a silica based gel. The gel blob may be formed to any desired shape by use of any suitable method.

It is of course obvious to the skilled man that such a transceiver 300 may be a transceiver with light emitting means only or with light sensing means only or with both in addition to the embodiment described herein comprising light emitting means 305 and first and second light sensing means 306, 304 for monitoring and controlling the performance of the light emitting means in addition to receiving optical signals.

Often optical data transmission systems use optical fibres 350 terminated by a ferrule. In order to comply with such systems, the packaged transceiver may be adapted to have a ferrule receiving means fitted thereto.

Referring now to FIGS. 7 and 8, an optical data transceiver 400 comprises an integrated circuit 401 upon which is implemented second light sensing means 404, light emitting means 405 and first light sensing means 406, a reflecting and receiving means 402 and bond pads 407, said bond pads being electrically connected to said integrated circuit 401.

The reflecting and receiving means 402 is operable to direct light emitted by the light emitting means 405 at wide angles into an optical fibre 450 and to direct light proceeding from the end of optical fibre 450 to the first and second light sensing means 406, 404. It is also operable to retain the optical fibre 450 in position relative to the light emitting means 405 and the first and second light sensing means 406, 404. The reflecting and receiving means 402 is mounted on to the integrated circuit 401. by adhesive 415. In order to direct light from the light emitting means 405 into the optical fibre 450, the reflecting and receiving means 402 has a curved inner surface 403 which is adapted to reflect a large proportion of incident light. The surface 403 may be adapted to reflect light by being polished, metallised or covered with a reflective coating. To improve reflective performance if the surface 403 is polished, the whole reflecting and receiving means 402 may be formed from white material.

Referring now to FIG. 8, the integrated circuit 401 is mounted on a lead frame 409. Connections are made by way of wires 408 (or any other suitable means) between the bond pads 407 on the integrated circuit 401 and peripheral potions of the lead frame 409 by means of which the optical transceiver 400 may be connected to external circuitry.

Once said integrated circuit 401 is mounted on said lead frame, said reflecting and receiving means 402 is mounted on said integrated circuit 401, said reflecting and receiving means being aligned so as to reflect light from said light emitting means into said optical fibre 450 and to reflect light from said optical fibre onto said light sensing means 406, 404.

In an alternative preferred embodiment, said reflecting and receiving means is attached to said integrated circuit whilst said integrated circuit is in wafer form.

Once the reflecting and receiving means 402 is in position, a blob of gel 410 is applied to the optically active elements. The blob of gel 410 may be amorphous or may be shaped so as to form a lens and accentuate the effect of the reflecting and receiving means 402. The integrated circuit 401, lead frame 409 and reflecting and receiving 402 are then placed into the cavity of a moulding tool. The cavity has a projection adapted to be in contact with said reflecting and receiving means 402.

A moulding compound 411 is then introduced into the cavity so as to encapsulate the integrated circuit 401, lead. frame 409 and reflecting and receiving 402 except for the peripheral portions of lead frame 409 and an opening corresponding to the position of the projection above said reflecting and receiving means. The moulding compound 411 provides protection for all the components of the optical transceiver 400 whilst leaving an opening through which an optical fibre 450 may be inserted to allow light to be directed to said light sensing means 404 and directed away from said light emitting means 405.

The gel blob 410 provides protection for the optically active elements during and after encapsulation. It is also possible that, the gel blob 410 may be added after encapsulation if the projection is adapted so as not to damage the optically active elements of the integrated circuit 401 during encapsulation or may even be omitted altogether, if desired. The gel may be any suitable transparent compound such as a transparent epoxy or a silica based gel. The gel blob 410 may be formed to any desired shape by use of any suitable method.

In a further alternative embodiment, it is possible that the reflecting and receiving means is not mounted to said integrated circuit 401 until after encapsulation. In such embodiments, a blob of gel 410 is applied to protect the optically active elements during encapsulation, the projection of the mould tool remaining in contact with the gel blob 410 during encapsulation, thereby providing an opening over said gel blob 410. The reflecting and receiving means 402 is then inserted into and mounted in said opening thus providing a packaged optical transceiver 400 as described above. In such embodiments, it is also possible that, if desired, the gel blob 410 may be omitted, provided that the projection is adapted so as not to damage the optically active elements of the integrated circuit 401 during encapsulation.

The above described methods may also be adapted to include the further step of applying Teflon tape to the unpackaged transceiver in the mould cavity, to cover at least the optically active elements. This provides additional protection for the optically active elements and is known as the Boschman Technique.

It is of course obvious to the skilled man that such a transceiver 400 may be a transceiver with light emitting means only or with light sensing means only or with both in addition to the embodiment described herein comprising light emitting means 405 and first and second light sensing means 406, 404 for monitoring and controlling the performance of the light emitting means in addition to receiving optical signals.

Often optical data transmission systems use optical fibres 450 terminated by a ferrule. In order to comply with such systems, the packaged transceiver may be adapted to have a ferrule receiving means fitted thereto.

It is of course to be understood that the invention is not intended to be restricted to details of the above embodiments which are described by way of example only.

1. A means for optically coupling an optical fibre to an integrated circuit: the circuit including at least one optically active element; and the means for coupling comprising reflecting and receiving means for mounting on a surface of said integrated circuit, said reflecting and receiving means being adapted to receive the optical fibre into optically coupled connection therewith.

2. A means for optically coupling an optical fibre to an integrated circuit as claimed in claim 1 wherein the reflecting and receiving means has two open ends and one end is preferably adapted to receive and retain an optical fibre and the second end is preferably adapted to fit around an optically active element or elements.

3. A means for optically coupling an optical fibre to an integrated circuit as claimed in claim 1 wherein the reflecting and receiving means has shaped and reflective inner surfaces operable to direct light from the optical fibre onto said optically active element or elements and to direct light from said optically active elements into said optical fibre.

4. A means for optically coupling an optical fibre to an integrated circuit as claimed in claim 3 wherein the inner surfaces are curved.

5. A means for optically coupling an optical fibre to an integrated circuit as claimed in claim 3 wherein a gel blob is applied to said optically active element or elements so as to form a lens to assist said reflecting and receiving means in directing light from said optical fibre to said optically active element or elements and in directing light from said optically active element or elements to said optical fibre.

6. A means for optically coupling an optical fibre to an integrated circuit as claimed in claim 1 wherein the reflecting and receiving means is mounted on the integrated circuit by means of adhesive.

7. A means for optically coupling an optical fibre to an integrated circuit as claimed in claim 1 wherein the integrated circuit is additionally provided with bond pads, which allow electrical connections to be made between the optically active element or elements and external circuitry.

8. A method of optically coupling an optical fibre to an integrated circuit, the integrated circuit including at least one optically active element, said coupling being achieved by the steps of: mounting on a surface of said integrated circuit reflecting and receiving means; and optically coupling said optical fibre to said reflecting and receiving means.

9. An optical data transceiver comprising: an integrated circuit comprising at least one optically active element; and a reflecting and receiving means mounted on said integrated circuit, said reflecting and receiving means for receiving and retaining the end of an optical fibre and for directing light from said optical fibre to said optically active element or elements and for directing light from said optically active element or elements to said optical fibre.

10. An optical data transceiver as claimed in claim 9 wherein the reflecting and receiving means has shaped and reflective inner surfaces.

11. An optical data transceiver as claimed in claim 10 wherein the inner surfaces are curved.

12. An optical data transceiver as claimed in claim 9 wherein the optical transceiver is an optical transceiver of the type comprising two optically active elements, a light emitting means and a light sensing means.

13. An optical data transceiver as claimed in claim 9 wherein the optical transceiver is an optical transceiver of the type comprising a single optically active element being a light emitting means.

14. An optical data transceiver as claimed in claim 9 wherein the optical transceiver is an optical transceiver of the type comprising a single optically active element being a light sensing means.

15. An optical data transceiver as claimed in claim 9 wherein the optical transceiver includes three optically active elements: a light emitting means operable to emit light in response to received electrical signals; a mounting means suitable for retaining an end of an optical fibre in position adjacent to said light emitting means; a first light sensing means operable to detect light emitted by the light emitting means and reflected from the end of said optical fibre, said first light sensing means being operable to output a signal indicative of the intensity of the reflected light; a second light sensing means operable to detect light incident upon said transceiver unit from an external source via said optical fibre and output electrical signals in response thereto; and control means operable to vary the intensity of the light emitted by the light emitting means in response to the output of the first light sensing means.

16. An optical data transceiver as claimed in claim 15 wherein said optical transceiver unit is adapted to transmit light of a first wavelength and to receive light of a second wavelength.

17. An optical data transceiver as claimed in claim 15 wherein said light emitting means is adapted to emit light of a first wavelength and said first light sensing means is adapted such that it detects substantially only light of said first wavelength.

18. An optical data transceiver as claimed claim 15 wherein said second light sensing device is an independent light sensing device or is a portion of the first light sensing means operable to provide a distinguishable signal and which is adapted such that it detects substantially only light of said second wavelength.

19. An optical data transceiver as claimed in claim 9 wherein the optical fibre is a plastic optical fibre (POF).

20. An optical data transceiver as claimed in claim 9 wherein a gel blob is applied to said optically active elements so as to form a lens to assist said reflector means in directing light from said optical fibre to said optically active element or elements and to direct light from said optically active element or elements to said optical fibre.

21. An optical data transceiver as claimed in claim 9 wherein the optically active elements are implemented on a single integrated circuit.

22. An optical data transceiver as claimed in claim 9 wherein the optically active elements are implemented on independent integrated circuits, said independent integrated circuits being electrically connected and physically fixed in a desired relative position.

23. An optical data transceiver as claimed in claim 9 wherein the integrated circuit is additionally provided with bond pads.

24. An optical data transceiver as claimed in claim 23 wherein the integrated circuit is mounted on a substrate or a lead frame and electrical connections between said bond pads provided on said integrated circuit and external circuitry are made via said substrate or lead frame.

25. A method of manufacturing optical data transceivers comprising the steps of: providing an array of integrated circuits on a wafer, each integrated circuit incorporating at least one optically active element; providing a corresponding array of reflecting and receiving means, each reflecting and receiving means within the array operable to retain the end of an optical fibre and to direct light from said optical fibre to said optically active element or elements of one of the integrated circuits and also operable to direct light from said optically active element or elements of one of the integrated circuits to said optical fibre; aligning said array of reflecting and receiving means with said array of integrated circuits and thereby mounting said array of reflecting and receiving means in alignment with said array of integrated circuits; and separating individual optical data transceivers from the array.

26. A method of manufacturing optical data transceivers as claimed in claim 25 wherein the wafer and the array of reflecting and receiving means are separated into individual optical data transceivers by sawing or laser scribing.

27. A method of manufacturing optical data transceivers as claimed in claim 25 wherein the wafer and array of reflecting and receiving means are separated into optical data transceivers incorporating two or more reflecting and receiving means and two or more integrated circuits.

28. A method of manufacturing optical data transceivers as claimed in claim 25 wherein the array of reflecting and receiving means provide a plurality of reflecting and receiving means for a corresponding plurality of optically active elements provided on each integrated circuit.

29. A method of manufacturing optical data transceivers as claimed in claim 25 wherein the method is used to manufacture optical data transceivers as claimed in any one of claims 9 to 24.

30. A method of manufacturing a packaged optical data transceiver comprising the following steps: providing an integrated circuit, the integrated circuit incorporating at least one optically active element; mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre; and dispensing a quantity of potting compound on to the surface of said integrated circuit such that only the reflector means and said optically active elements are left uncovered.

31. A method of manufacturing a packaged optical data transceiver as claimed in claim 30 wherein the method further comprises the steps of: providing bond pads on said integrated circuit; mounting said integrated circuit on a suitable substrate; and forming electrical connections between said bond pads and said substrate before dispensing said potting compound.

32. A method of manufacturing a packaged optical data transceiver as claimed in claim 31 wherein said potting compound is dispensed so as to cover substantially the whole of the substrate in addition to the integrated circuit.

33. A method of manufacturing a packaged optical data transceiver as claimed in claim 32 wherein the potting compound is applied in such a manner as to leave exposed bond pads or other means for electrically connecting the substrate to external circuitry.

34. A method of manufacturing a packaged optical data transceiver as claimed in claim 33 wherein contacts for external electrical connections are provided on the opposite side of the substrate to that the integrated circuit is mounted on and vias are provided in the substrate.

35. A method of manufacturing a packaged optical data transceiver comprising the following steps: providing an integrated circuit, the integrated circuit incorporating at least one optically active element; mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre, thereby forming an assembly; inserting the assembly into a cavity of a moulding tool ensuring that at least a projection of the moulding tool is in contact with and seals with the reflecting and receiving means; introducing a plastic mould compound into the cavity so as to encapsulate the assembly except for the portion in contact with the projection; and removing the assembly from the cavity, whereby there is an opening defined in the plastic mould encapsulating the assembly through which light may pass to the optically active element or elements.

36. A method as claimed in claim 35 wherein the method further comprises the steps of: providing bond pads on said integrated circuit; mounting said integrated circuit on a suitable lead frame; and forming electrical connections between said bond pads and said lead frame before inserting the assembly into the moulding tool.

37. A method as claimed in claim 36 wherein the peripheral portions of the lead frame are not encapsulated.

38. A method of manufacturing a packaged optical data transceiver comprising the following steps: providing an integrated circuit, the integrated circuit incorporating at least one optically active element; applying a quantity of gel to the integrated circuit to cover at least the optically active elements, thereby forming a gel-coated assembly; inserting the gel-coated assembly into a cavity of a moulding tool ensuring that at least a projection of the moulding tool is in contact with the gel-coated assembly; introducing a plastic mould compound into the cavity so as to encapsulate the gel-coated assembly except for the portion in contact with the projection; removing the assembly from the cavity, whereby there is an opening defined in the plastic mould encapsulating the assembly through which the assembly can be accessed; and mounting a reflecting and receiving means on said integrated circuit, said reflecting and receiving means being operable to retain the end of an optical fibre and to direct light from said optical fibre to said optically active element or elements of one of the integrated circuits and also operable to direct light from said optically active element or elements of one of the integrated circuits to said optical fibre.

39. A method as claimed in claim 38 wherein the method further comprises the steps of: providing bond pads on said integrated circuit; mounting said integrated circuit on a suitable lead frame; and forming electrical connections between said bond pads and said lead frame before inserting the assembly into the moulding tool.

40. A method as claimed in claim 38 wherein the peripheral portions of the lead frame are not encapsulated.

41. A packaged optical data transceiver manufactured in accordance with the method of claim 30.

42. (canceled)
